(19) United States
(12) Patent Application Publication
(10) Pub. No.: US 2026/0243969 A1
(43) Pub. Date: Aug. 20, 2026

(54) QUARTZ BLOCK HEAD CONNECTOR THAT INCLUDES AT LEAST ONE COOLANT CHANNEL WITH A THREE-DIMENSIONAL CONTOURED GEOMETRY

(71) Applicant: Lumentum Operations LLC, San Jose, CA (US)

(72) Inventors: Alen BUCAR, Trebnje (SI); Jure NOVAK, Grosuplje (SI); Jan HRIBAR, Grahovo (SI)

(21) Appl. No.: 19/206,356

(22) Filed: May 13, 2025

Related U.S. Application Data
(60) Provisional application No. 63/760,160, filed on Feb. 19, 2025.

(51) Int. Cl. G02B 6/38

(52) U.S. Cl. CPC G02B 6/3814; G02B 6/3813; G02B 6/3826; G02B 6/3834; G02B 6/3854

(57) ABSTRACT

In some implementations, a QBH connector includes a monolithic connector body. The monolithic connector body includes a fiber ferrule alignment region, a quartz block, and an internal coolant channel system. The internal coolant channel system includes at least one coolant channel that has a 3D contoured geometry.

### CROSS-REFERENCE TO RELATED APPLICATION

This Patent Application claims priority to U.S. Patent Application No. 63/760,160, filed on Feb. 19, 2025, and entitled “QUARTZ BLOCK HEAD CONNECTOR WITH CONFORMAL COOLING.” The disclosure of the prior Application is considered part of and is incorporated by reference into this Patent Application.

### TECHNICAL FIELD

The present disclosure relates generally to a quartz block head (QBH) connector and to a QBH connector that includes at least one coolant channel with a three-dimensional (3D) contoured geometry.

### BACKGROUND

QBH connectors are often used in high-power industrial laser systems for fiber-optic beam delivery. QBH connectors are designed to handle high-power laser beams efficiently and safely, in applications such as laser cutting, welding, and engraving.

### SUMMARY

In some implementations, a QBH connector includes a monolithic connector body that includes: a fiber ferrule alignment region; a quartz block; and an internal coolant channel system that includes a coolant channel that has a 3D contoured geometry.

In some implementations, a QBH connector includes a monolithic connector body that includes at least one coolant channel that has a 3D contoured geometry.

In some implementations, a monolithic connector body of a QBH connector includes an internal coolant channel system that includes at least one coolant channel that has a 3D contoured geometry.

### BRIEF DESCRIPTION OF THE DRAWINGS

FIG. 1 is a diagram of an example QBH connector that includes at least one coolant channel with a 3D contoured geometry.

FIG. 2 is a diagram of an example implementation associated with a QBH connector that includes at least one coolant channel with a 3D contoured geometry.

FIGS. 3A-3C are diagrams of example implementations associated with a QBH connector that includes at least one coolant channel with a 3D contoured geometry.

### DETAILED DESCRIPTION

The following detailed description of example implementations refers to the accompanying drawings. The same reference numbers in different drawings may identify the same or similar elements.

QBH connectors often connect optical fibers to laser sources or processing heads. In a QBH connector, a key challenge is managing heat generated by absorption of back-reflected laser light, particularly when a target material is highly reflective. In many cases, light is absorbed by the QBH connector's body, creating localized hotspots. To mitigate this, water or another coolant can be circulated through machined channels within the connector body to dissipate the heat.

A QBH connector can be constructed from multiple machined parts, such as at least two separate cylindrical or tubular metal parts. The parts are drilled or milled (e.g., using subtractive machining processes) to create internal coolant passages. The parts are then assembled, such as by using welding or press-fitting, to connect the parts and to seal the coolant channels. However, due to the limitations of subtractive machining processes, the resulting coolant channel geometries are often simple and linear, lacking the ability to conform closely to regions of high heat generation within the QBH connector. This leads to inefficient heat removal and suboptimal thermal performance. Additionally, each joint or interface (e.g., each weld seam or press-fit interface) of the assembled QBH connector introduces a potential leak path, necessitating extensive testing to ensure channel integrity. The combined demands of precise machining, secure assembly, leak prevention, and post-processing contribute to a manufacturing workflow that is complex, resource-intensive, and costly.

As a result of the limitations in QBH connector design, several key challenges persist. These include inefficient cooling due to an inability to direct coolant precisely to high-heat regions, leading to elevated operating temperatures; localized thermal hotspots that constrain a maximum power that the QBH connector can safely handle; and complex, resource-intensive manufacturing processes involving multiple precision-machined and welded components. These challenges collectively hinder performance, increase production costs, and reduce reliability of a QBH connector. Furthermore, high-power laser systems place growing demands on thermal management to preserve beam quality and extend QBH connector lifespan. Consequently, there is a clear need for an improved QBH connector design, one that enables more targeted heat dissipation, supports higher power levels, simplifies manufacturing, and enhances the long-term reliability of QBH connectors.

Some implementations described herein include a QBH connector. The QBH connector comprises a connector body that includes an internal coolant channel system, which includes at least one coolant channel with a 3D contoured geometry. For example, a coolant channel may have a non-uniform cross-sectional area along at least a portion of a length of the coolant channel, may have a non-uniform cross-sectional shape along at least a portion of a length of the coolant channel, and/or may follow a 3D non-linear path along at least a portion of a length of the coolant channel. In some implementations, a coolant channel helically extends around a central longitudinal axis of the connector body (e.g., completing at least one revolution around the central longitudinal axis).

In this way, some implementations described herein enable a more optimal cooling path (and/or more optimal coolant flow) within the QBH connector. For example, because at least one coolant channel has a 3D contoured geometry, a complex coolant channel structure can be formed within the connector body of the QBH connector, which enables more targeted heat dissipation. As another example, a coolant channel that has a 3D contoured geometry may be spaced from an outer surface of the connector body by a substantially uniform distance for at least a portion (e.g., a majority portion) of a length of the coolant channel, which enables more uniform heat dissipation for a region of the surface of the connector body that corresponds to the portion of the length of the coolant channel.

Accordingly, by having at least one coolant channel that has a 3D contoured geometry within the QBH connector, the QBH connector has improved thermal management. By allowing coolant to flow more precisely around areas of high heat concentration (also referred to as “conformal cooling”), some implementations reduce overall operating temperatures and minimize localized thermal hotspots. As a result, the QBH connector can safely operate at higher power levels without compromising beam quality or risking thermal damage. Therefore, some implementations not only enhance performance but also extend the operational lifespan of the QBH connector, enabling increased reliability and efficiency for high-power laser systems.

In some implementations, the connector body of the QBH connector is a monolithic connector body. That is, the connector body may comprise a unitary body, formed of a continuous material, such as metal. In this way, the connector body eliminates, or minimizes a number of, interfaces or joints of the connector body, which enhances a mechanical robustness, thermal conductivity, and sealing integrity (e.g., with respect to a coolant that is to flow within coolant channels of the QBH connector) of the connector body.

In some implementations, to enable formation of at least one coolant channel with a 3D contoured geometry within a monolithic connector body, an additive manufacturing (AM) process may be used, such as direct metal laser sintering (DMLS), selective laser melting (SLM), and/or electron beam melting (EBM). An AM process eliminates many of the constraints of traditional machining and therefore enables formation of coolant channels with a 3D contoured geometry that could not otherwise be practically formed using traditional subtractive manufacturing processes. Further, an AM process enables formation of the connector body, and components within the connector body, as a unitary piece, and therefore reduces a number of needed weld seams and press-fit interfaces, or other interfaces or joints. This reduces a complexity involved with forming the connector body and therefore simplifies manufacturing; reduces a number of potential leak points; and improves a thermal profile of the connector body, which enables more efficient cooling of the QBH connector.

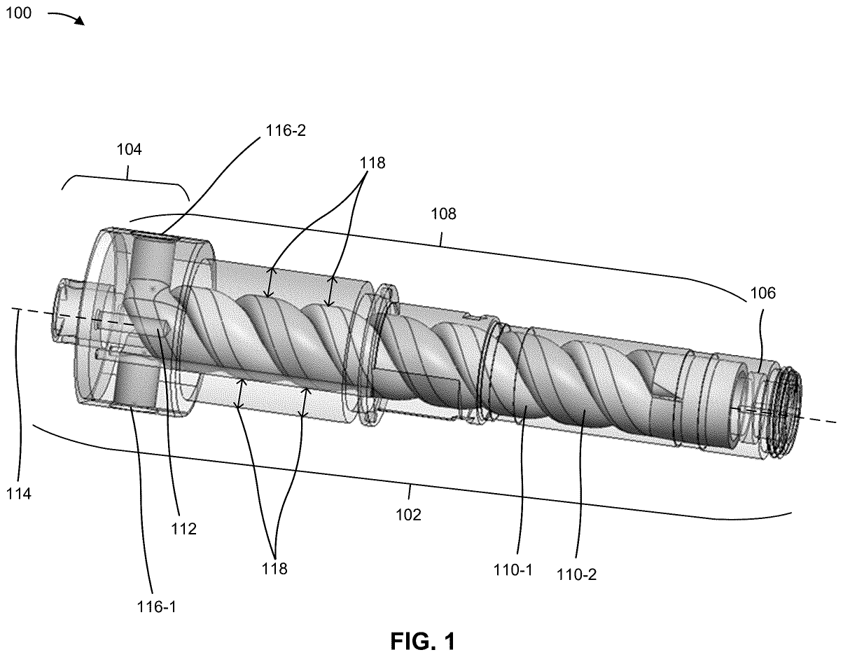

FIG. 1 is a diagram of an example QBH connector 100. As shown in FIG. 1, the QBH connector 100 includes a connector body 102, which includes a fiber ferrule alignment region 104, a quartz block 106, and an internal coolant channel system 108 that comprises at least one coolant channel 110.

As shown in FIG. 1, the connector body 102 defines an internal environment of the QBH connector 100, within which the fiber ferrule alignment region 104, the quartz block 106, and the internal coolant channel system 108 are located. The connector body 102 may be a monolithic connector body. That is, the connector body 102 may comprise a unitary body, formed of a continuous material, such as metal. In this way, the connector body 102 eliminates, or minimizes a number of, interfaces or joints of the connector body 102, which enhances a mechanical robustness, thermal conductivity, and sealing integrity (e.g., with respect to a coolant, as further described herein) of the connector body 102.

The fiber ferrule alignment region 104 includes a fiber ferrule 112 that is configured to hold an optical fiber (e.g., that transmits a laser beam) in a particular position and orientation. For example, the fiber ferrule 112 may hold the optical fiber to facilitate alignment of a core of the optical fiber with a central longitudinal axis 114 (shown as a dashed line) of the connector body 102, which may be an optical axis of the connector body 102.

The quartz block 106 is included in an end (e.g., an emission end) of the connector body 102. The quartz block 106 is configured to absorb reflected (e.g., back-reflected) or stray laser light that is associated with transmission of the laser beam from the optical fiber, through the connector body 102, and to a target (e.g., when the target includes a reflective material). Accordingly, the quartz block 106, as well as the connector body 102, may act as a protective component for the optical fiber.

During operation, the connector body 102, the fiber ferrule alignment region 104, and/or the quartz block 106, may accumulate heat, as a result of transmission of a laser beam (e.g., a high-powered laser beam) and/or absorption of reflected or stray laser light. Thus, the connector body 102 includes the internal coolant channel system 108 to transfer at least some of the heat (e.g., by conduction or convection) from the connector body 102, which prevents, or at least reduces, thermal distortion; facilitates optical alignment of the core of the optical fiber with the central longitudinal axis 114 of the connector body 102; and prevents, or reduces, material degradation of the connector body 102, the fiber ferrule 112, and the quartz block 106 over time.

The internal coolant channel system 108 includes at least one coolant channel 110, shown as a first coolant channel 110-1 and a second coolant channel 110-2 in FIG. 1. Each coolant channel 110 is configured to allow a coolant to flow through the connector body 102 via the coolant channel 110 (e.g., from an input end of the coolant channel 110 to an output end of the coolant channel 110) to transfer heat from the connector body 102 (e.g., that is produced by transmission of a laser beam and/or absorption of reflected or stray laser light). While FIG. 1 shows two coolant channels 110, any number (e.g., 1, 2, 3, or more) of coolant channels 110 may be included in the internal coolant channel system 108.

In some implementations, one coolant channel 110 may be connected (e.g., fluidly connected) to another coolant channel 110. For example, as shown in FIG. 1, the first coolant channel 110-1 may be an “input” coolant channel that allows coolant to flow into the connector body 102, and the second coolant channel 110-2 may be an “output” coolant channel that allows coolant to flow out of the connector body 102. The first coolant channel 110-1 therefore may be connected to the second coolant channel 110-2 (e.g., an output end of the first coolant channel 110-1 may be connected to an input end of the second coolant channel 110-2 to allow a coolant to flow into and out of the connector body 102. Accordingly, the first coolant channel 110-1 may be configured to direct a coolant, within the connector body 102, in a first direction (e.g., that is aligned with the central longitudinal axis 114 of the connector body 102) and the second coolant channel 110-2 may be configured to direct the coolant, within the connector body 102, in a second direction (e.g., that is different than the first direction, such as opposite of the first direction).

At least one of the coolant channels 110 may have a 3D contoured geometry. That is, a coolant channel 110 may have a non-uniform cross-sectional area along at least a portion of a length of the coolant channel 110, may have a non-uniform cross-sectional shape along at least a portion of a length of the coolant channel 110, and/or may follow a 3D non-linear path along at least a portion of a length of the coolant channel 110 (e.g., the coolant channel 110 may exhibit continuous and/or compound curvature and/or torsion, such as in all three spatial dimensions, along at least a portion of a length of the coolant channel 110). In some implementations, a coolant channel 110 helically extends around the central longitudinal axis 114 of the connector body 102 (e.g., completing at least one revolution around the central longitudinal axis 114). For example, as shown in FIG. 1, each of the first coolant channel 110-1 and the second coolant channel 110-2 extends around the central longitudinal axis 114 of the connector body 102 to form a double helical coolant channel structure. While FIG. 1 shows two coolant channels 110 with respective 3D geometries, any number (e.g., 1, 2, 3, or more) of coolant channels 110 may have a 3D geometry.

In some implementations, because at least one coolant channel 110 has a 3D contoured geometry, multiple coolant channels 110 can form complex coolant channel structures within the connector body 102, such as the double helical coolant channel structure shown in FIG. 1. As another example, coolant channels 110 may form a triple helical coolant channel structure, a quadruple helical coolant channel structure, or more, where each coolant channel 110 extends around the central longitudinal axis 114 of the connector body 102. In another example, one or more coolant channels 110 may have a linear geometry (e.g., each coolant channel may follow a path described by a vector along at least a portion of a length of the coolant channel 110) and at least one other coolant channel 110 may have a 3D contoured geometry, which allows for the at least one other coolant channel 110 to helically extend around the one or more coolant channels 110, to be intertwined with the one or more coolant channels 110, and/or to form other coolant channel structures.

In some implementations, at least one coolant channel 110 (e.g., the first coolant channel 110-1 and/or another coolant channel 110) may be embedded within another coolant channel 110 (e.g., the second coolant channel 110-2). That is, at least one coolant channel 110 may be formed within another coolant channel 110. For example, a coolant channel 110 and another coolant channel 110 may each follow a 3D non-linear path, where the coolant channel 110 is formed within the other coolant channel 110. As another example, a coolant channel 110 may follow a 3D non-linear path, and may be contained within another coolant channel 110 that follows a linear path.

In some implementations, at least one coolant channel 110 may be spaced from an outer surface of the connector body 102 by a substantially uniform distance (e.g., a uniform distance, within a threshold, such as 1 millimeter (mm), 2 mm, or 3 mm) for at least a portion of a length of the at least one coolant channel 110. For example, as shown in FIG. 1, each of the first coolant channel 110-1 and the second coolant channel 110-1 may be spaced from an outer surface of the connector body by a substantially uniform distance 118 for at least respective portions of the lengths of the first coolant channel 110-1 and the second coolant channel 110-2.

The connector body 102 may include one or more ports 116, shown as a first port 116-1 and a second port 116-2 in FIG. 1. A port 116 may connect (e.g., fluidly connect) to one or more coolant channels 110, such as to allow coolant to flow to or from the one or more coolant channels 110. For example, as shown in FIG. 1, the first port 116-1 may be an input port that is connected to the first coolant channel 110-1 and configured to provide coolant to the first coolant channel 110-1 (e.g., to allow the coolant to flow into the connector body 102), and the second port 116-2 may be an output port that is connected to the second coolant channel 110-2 and configured to direct coolant from the second coolant channel 110-2 (e.g., to allow the coolant to flow from the connector body 102). Alternatively (not shown in FIG. 1.), the second port 116-2 may be an output port located at another longitudinal position along connector body 102. Further, the first port 116-1 may be an input port and may connect to one end of first coolant channel 110-1 and the second port 116-2 may be an output port and may connect to a second end of the first coolant channel 110-1.

In some implementations, a port 116 includes multiple portions (e.g., multiple sections) that respectively connect to multiple coolant channels 110 (e.g., when the internal coolant channel system 108 includes multiple coolant channels 110). For example, a port 116 may include a first portion that connects to the first coolant channel 110-1, a second portion that connects to the second coolant channel 110-2, and so on. In this way, a port 116 can be an input port for multiple input coolant channels 110, can be an output port for multiple output coolant channels 110, or can be an input and output (“input/output”) port for one or more input coolant channels 110 and one or more output coolant channels 110. Such a configuration is feasible when at least one output channel 110 has a 3D contoured geometry, as described herein.

As indicated above, FIG. 1 is provided as an example. Other examples may differ from what is described with regard to FIG. 1.

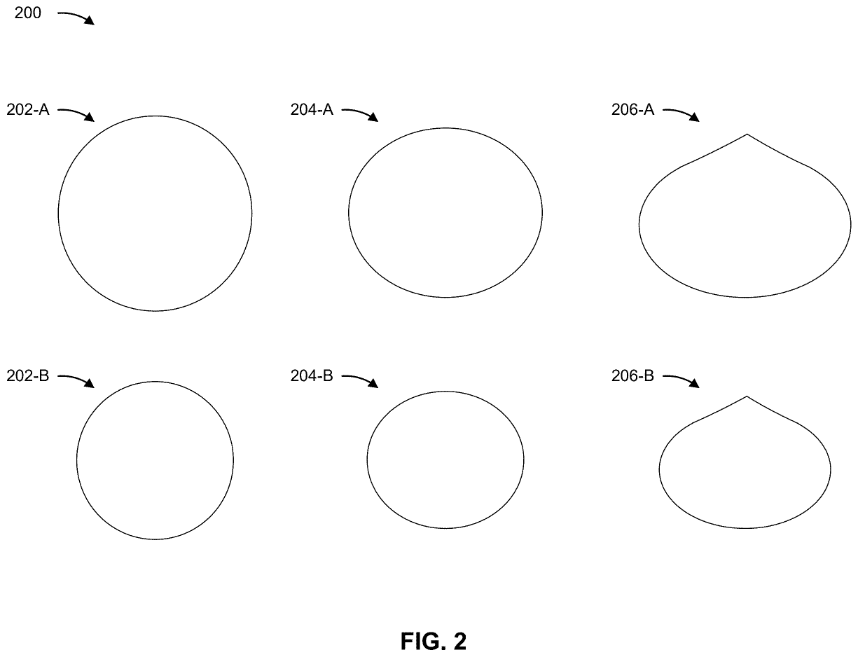

FIG. 2 is a diagram of an example implementation 200 associated with a QBH connector that includes at least one coolant channel with a three-dimensional contoured geometry. FIG. 2 shows potential cross-sections 202 (cross-sections with differently sized circular shapes), 204 (cross-sections with differently sized elliptical shapes), and 206 (cross-sections with differently sized tear-drop shapes) of an example coolant channel 110 that has a 3D contoured geometry at different locations (e.g., at “A” locations and at “B” locations) along a length of the coolant channel 110.

For example, when the coolant channel 110 includes cross-sections 202-A and 202-B, the coolant channel 110 may have a uniform cross-sectional shape (e.g., a circular shape) along at least a portion of the length of the coolant channel 110 (e.g., from a location associated with cross-section 202-A to a location associated with cross-section 202-B), and may have a non-uniform cross-sectional area (e.g., because the cross-sectional area at cross-section 202-A is greater than the cross-sectional area at cross-section 202-B) along at least the portion of the length of the coolant channel 110. Alternatively, when the coolant channel 110 includes a cross-section 202 (e.g., one of cross-section 202-A or cross-section 202-B) and either a cross-section 204 (e.g., one of cross-section 204-A or cross-section 204-B) or a cross-section 206 (e.g., one of cross-section 206-A or cross-section 206-B), the coolant channel 110 may have a non-uniform cross-sectional shape along at least a portion of the length of the coolant channel 110 (e.g., from a location associated with the cross-section 202 to a location associated with either cross-section 204 or cross-section 206).

As another example, when the coolant channel 110 includes cross-sections 204-A and 204-B, the coolant channel 110 may have a uniform cross-sectional shape (e.g., an elliptical shape) along at least a portion of the length of the coolant channel 110 (e.g., from a location associated with cross-section 204-A to a location associated with cross-section 204-B), and may have a non-uniform cross-sectional area (e.g., because the cross-sectional area at cross-section 204-A is greater than the cross-sectional area at cross-section 204-B) along at least the portion of the length of the coolant channel 110. Alternatively, when the coolant channel 110 includes a cross-section 204 (e.g., one of cross-section 204-A or cross-section 204-B) and either a cross-section 202 (e.g., one of cross-section 202-A or cross-section 202-B) or a cross-section 206 (e.g., one of cross-section 206-A or cross-section 206-B), the coolant channel 110 may have a non-uniform cross-sectional shape along at least a portion of the length of the coolant channel 110 (e.g., from a location associated with the cross-section 204 to a location associated with either cross-section 202 or cross-section 206).

In an additional example, when the coolant channel 110 includes cross-sections 206-A and 206-B, the coolant channel 110 may have a uniform cross-sectional shape (e.g., a tear-drop shape) along at least a portion of the length of the coolant channel 110 (e.g., from a location associated with cross-section 206-A to a location associated with cross-section 206-B), and may have a non-uniform cross-sectional area (e.g., because the cross-sectional area at cross-section 206-A is greater than the cross-sectional area at cross-section 206-B) along at least the portion of the length of the coolant channel 110. Alternatively, when the coolant channel 110 includes a cross-section 206 (e.g., one of cross-section 206-A or cross-section 206-B) and either a cross-section 202 (e.g., one of cross-section 202-A or cross-section 202-B) or a cross-section 204 (e.g., one of cross-section 204-A or cross-section 204-B), the coolant channel 110 may have a non-uniform cross-sectional shape along at least a portion of the length of the coolant channel 110 (e.g., from a location associated with the cross-section 206 to a location associated with either cross-section 202 or cross-section 204).

As indicated above, FIG. 2 is provided as an example. Other examples may differ from what is described with regard to FIG. 2.

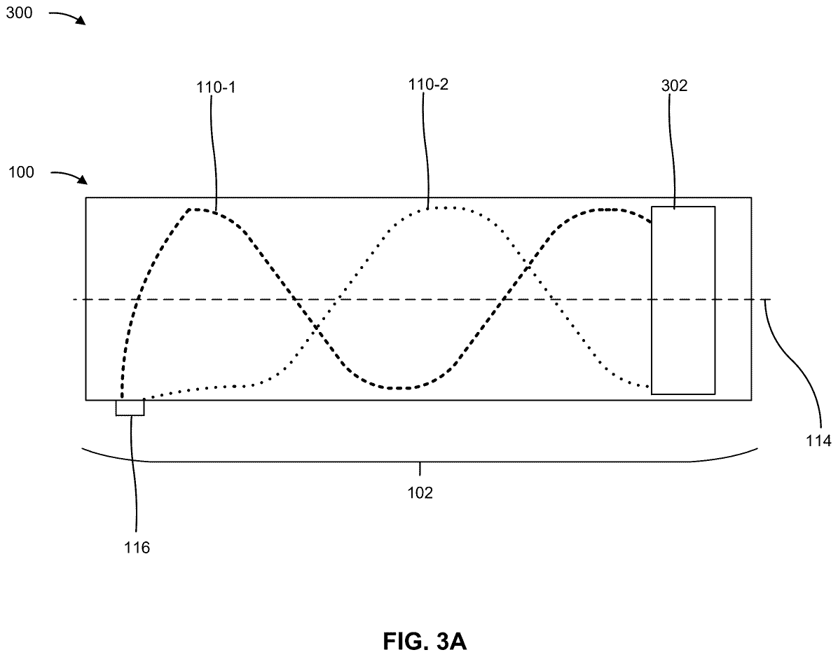

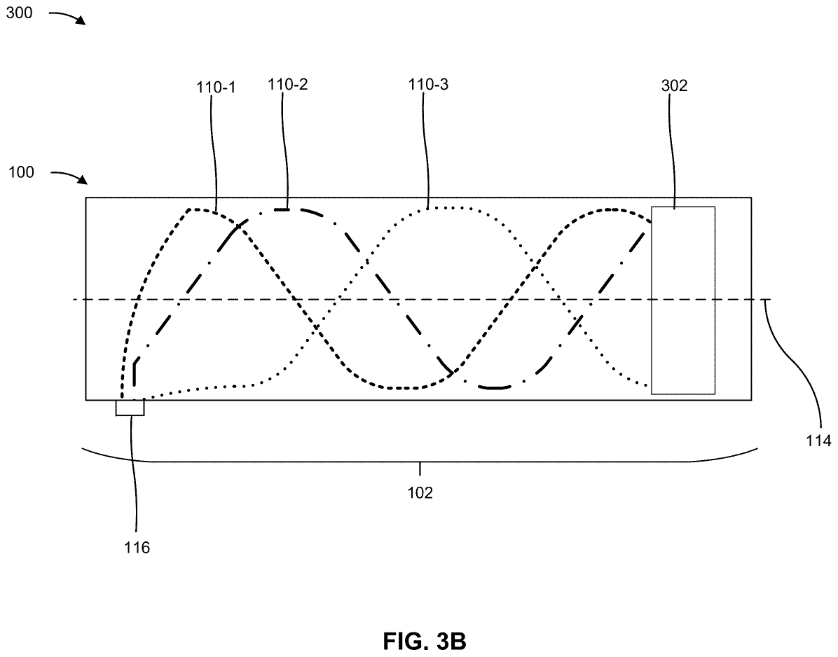

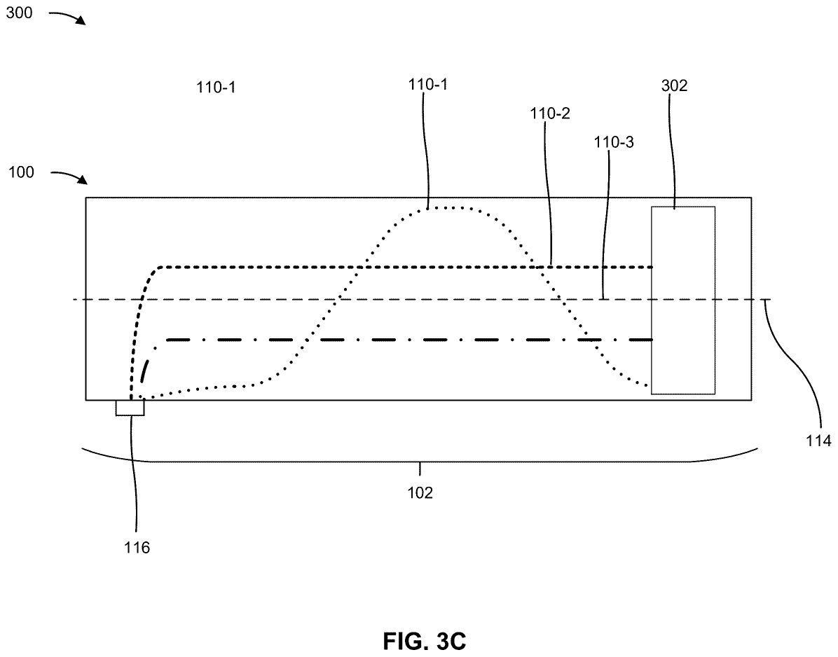

FIGS. 3A-3C are diagrams of example implementations 300 associated with a QBH connector that includes at least one coolant channel with a three-dimensional contoured geometry. FIGS. 3A-3C show examples of different coolant channel structures within the connector body 102 of the QBH connector 100.

FIG. 3A shows a double helical coolant channel structure. As shown in FIG. 3A, each of a first coolant channel 110-1 and a second coolant channel 110-2 helically extends around the central longitudinal axis 114 of the connector body 102 (e.g., completing at least one revolution around the central longitudinal axis 114). As further shown in FIG. 3A, each of the first coolant channel 110-1 and the second coolant channel 110-2 may connect to a port 116 (e.g., a single port 116) of the connector body 102 (e.g., via respective portions of the port 116). The first coolant channel 110-1 and the second coolant channel 110-2 may also connect to each other via a connector 302 (e.g., a reservoir, a chamber, or other type of connector). The first coolant channel 110-1 and the second coolant channel 110-2 may be input coolant channels, output coolant channels, or a combination of an input coolant channel and an output coolant channel.

FIG. 3B shows a triple helical coolant channel structure. As shown in FIG. 3B, each of a first coolant channel 110-1, a second coolant channel 110-2, and a third coolant channel 110-3 helically extends around the central longitudinal axis 114 of the connector body 102 (e.g., completing at least one revolution around the central longitudinal axis 114). As further shown in FIG. 3B, each of the first coolant channel 110-1, the second coolant channel 110-2, and third coolant channel 110-3 may connect to a port 116 (e.g., a single port 116) of the connector body 102 (e.g., via respective portions of the port 116). At least some of the first coolant channel 110-1, the second coolant channel 110-2, and the third coolant channel 110-3 may also connect to each other via a connector 302. The first coolant channel 110-1, the second coolant channel 110-2, and the third coolant channel 110-3 may be input coolant channels, output coolant channels, or a combination of one or more input coolant channels and one or more output coolant channels.

FIG. 3C shows a single helical coolant channel structure. As shown in FIG. 3C, a first coolant channel 110-1 helically extends around the central longitudinal axis 114 of the connector body 102 (e.g., completing at least one revolution around the central longitudinal axis 114). Additionally, portions of a second coolant channel 110-2 and a third coolant channel 110-3 follow respective linear paths. Accordingly, the first coolant channel 110-1 may helically extend around at least one of the second coolant channel 110-2 or the third coolant channel 110-3. As further shown in FIG. 3C, each of the first coolant channel 110-1, the second coolant channel 110-2, and third coolant channel 110-3 may connect to a port 116 (e.g., a single port 116) of the connector body 102 (e.g., via respective portions of the port 116). At least some of the first coolant channel 110-1, the second coolant channel 110-2, and the third coolant channel 110-3 may also connect to each other via a connector 302. The first coolant channel 110-1, the second coolant channel 110-2, and the third coolant channel 110-3 may be input coolant channels, output coolant channels, or a combination of one or more input coolant channels and one or more output coolant channels.

As indicated above, FIGS. 3A-3C are provided as an example. Other examples may differ from what is described with regard to FIGS. 3A-3C.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A quartz block head (QBH) connector, comprising:
a monolithic connector body that includes:
a fiber ferrule alignment region;
a quartz block; and
an internal coolant channel system that includes:
a coolant channel that has a three-dimensional (3D) contoured geometry.

2. The QBH connector of claim 1, wherein:
the coolant channel has a non-uniform cross-sectional area along at least a portion of a length of the coolant channel.

3. The QBH connector of claim 1, wherein:
the coolant channel has a non-uniform cross-sectional shape along at least a portion of a length of the coolant channel.

4. The QBH connector of claim 1, wherein:
the coolant channel helically extends around a central longitudinal axis of the monolithic connector body, completing at least one revolution around the central longitudinal axis.

5. The QBH connector of claim 1, wherein at least one of:
the coolant channel is spaced from an outer surface of the monolithic connector body by a substantially uniform distance for at least a majority portion of a length of the coolant channel.

6. The QBH connector of claim 1, wherein the monolithic connector body further includes:
another coolant channel that has another 3D contoured geometry.

7. The QBH connector of claim 6, wherein:
the coolant channel is configured to direct a coolant, within the monolithic connector body, in a first direction; and
the other coolant channel is configured to direct the coolant, within the monolithic connector body, in a second direction.

8. The QBH connector of claim 1, wherein:
the coolant channel is intertwined with another coolant channel included in the monolithic connector body.

9. The QBH connector of claim 1, wherein the monolithic connector body further includes:
at least two other coolant channels with other respective 3D contoured geometries.

10. The QBH connector of claim 1, wherein the monolithic connector body further includes:
a port that includes a first portion that connects to the coolant channel and a second portion that connects to another coolant channel included in the monolithic connector body.

11. A quartz block head (QBH) connector, comprising:
a monolithic connector body that includes:
at least one coolant channel that has a three-dimensional (3D) contoured geometry.

12. The QBH connector of claim 11, wherein the at least one coolant channel has a non-uniform cross-sectional area along at least a portion of a length of the at least one coolant channel.

13. The QBH connector of claim 11, wherein the at least one coolant channel has a non-uniform cross-sectional shape along at least a portion of a length of the at least one coolant channel.

14. The QBH connector of claim 11, wherein the at least one coolant channel extends around a central longitudinal axis of the monolithic connector body, completing at least one revolution around the central longitudinal axis.

15. The QBH connector of claim 11, wherein the at least one coolant channel is spaced from an outer surface of the monolithic connector body by a substantially uniform distance for at least a majority portion of a length of the at least one coolant channel.

16. A monolithic connector body of a quartz block head (QBH) connector, comprising:
an internal coolant channel system that includes at least one coolant channel that has a three-dimensional (3D) contoured geometry.

17. The monolithic connector body of claim 16, wherein the at least one coolant channel has at least one of a non-uniform cross-sectional area or a non-uniform cross-sectional shape along at least a portion of a length of the at least one coolant channel.

18. The monolithic connector body of claim 16, wherein the at least one coolant channel extends around a central longitudinal axis of the monolithic connector body, completing at least one revolution around the central longitudinal axis.

19. The monolithic connector body of claim 16, wherein the at least one coolant channel is spaced from an outer surface of the monolithic connector body by a substantially uniform distance for at least a majority portion of a length of the at least one coolant channel.

20. The monolithic connector body of claim 16, wherein the at least one coolant channel is intertwined with another coolant channel included in the monolithic connector body.
